(19) United States
(12) Patent Application Publication
(10) Pub. No.: US 2024/0334278 A1
(43) Pub. Date: Oct. 3, 2024

(54) METHOD AND APPARATUS FOR MANAGING REFERENCE CELL CONFIGURATION FOR L1/L2-TRIGGERED HANDOVER IN NEXT-GENERATION MOBILE COMMUNICATION SYSTEM

(71) Applicant: Samsung Electronics Co., Ltd., Suwon-si (KR)

(72) Inventors: Seungri JIN, Suwon-si (KR); June HWANG, Suwon-si (KR)

(21) Appl. No.: 18/619,737

(22) Filed: Mar. 28, 2024

(30) Foreign Application Priority Data
Mar. 31, 2023 (KR) 10-2023-0043142

(51) Int. Cl. H04W 36/04; H04W 36/00; H04W 36/24

(52) U.S. Cl. CPC H04W 36/04; H04W 36/0033; H04W 36/24

(57) ABSTRACT

A method performed by a terminal in a communication system is provided. The method includes receiving, from a gNodeB (gNB), a radio resource control (RRC) message including at least one layer 1/layer 2 triggered mobility (LTM) candidate configuration, receiving, from the gNB, a medium access control (MAC) control element (CE) associated with an LTM, identifying that an LTM is triggered based on the MAC CE, and applying an LTM candidate configuration for the LTM in case that the LTM candidate configuration includes information indicating that the LTM candidate configuration is a complete configuration.

### CROSS-REFERENCE TO RELATED APPLICATION(S)

This application is based on and claims priority under 35 U.S.C. § 119 (a) of a Korean patent application number 10-2023-0043142, filed on Mar. 31, 2023, in the Korean Intellectual Property Office, the disclosure of which is incorporated by reference herein in its entirety.

### BACKGROUND

### 1. Field

The disclosure relates to operations of a user equipment (UE) and a gNB in a mobile communication system.

### 2. Description of Related Art

Fifth-generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement sixth-generation (6G) mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio user equipment (NR UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method wherein, if a user equipment (UE) is receiving a service through a specific beam from the current serving cell, and if a beam of a neighbor cell becomes better as a result of measuring and reporting beams belonging to other cells, a cell change to the corresponding cell is indicated through L1/L2 signaling, and the cell change is thus performed. Before receiving the L1/L2 signaling, the UE may receive configurations regarding neighbor cells in advance and may store and manage configurations regarding respective target candidate cells. In this regard, the UE may manage configurations regarding target candidate cells with reference to the reference cell configuration. However, there are insufficient detailed operations regarding a method for managing the reference cell configuration for supporting subsequent L1/L2 signaling-triggered handovers. In particular, there is a need for a method for managing the no reference cell configuration if the same does not exist.

Additional aspects will be set forth in part in the description which follows and, in part, will be apparent from the description, or may be learned by practice of the presented embodiments.

In accordance with an aspect of the disclosure, a method performed by a terminal in a communication system is provided. The method includes receiving, from a gNodeB (gNB), a radio resource control (RRC) message including at least one layer 1/layer 2 triggered mobility (LTM) candidate configuration, receiving, from the gNB, a medium access control (MAC) control element (CE) associated with an LTM, identifying that an LTM is triggered based on MAC CE, and applying an LTM candidate configuration for the LTM in case that the LTM candidate configuration includes information indicating that the LTM candidate configuration is a complete configuration.

In accordance with another aspect of the disclosure, a method performed by a central unit (CU) associated with a gNodeB (gNB) in a communication system is provided. The method includes transmitting, to a distributed unit (DU) associated with the gNB, a context setup request message, receiving, from the DU, a response message including at least one layer 1/layer 2 triggered mobility (LTM) candidate configuration as a response to the context setup request message, transmitting, to a terminal, a radio resource control (RRC) message including the at least one LTM candidate configuration; and transmitting, to the terminal, a medium access control (MAC) control element (CE) associated with an LTM, wherein an LTM candidate configuration for the LTM is applied in case that the LTM candidate configuration includes information indicating that the LTM candidate configuration is a complete configuration.

In accordance with another aspect of the disclosure, a terminal in a communication system is provided. The terminal includes a transceiver, and at least one processor coupled to the transceiver and configured to receive, from a gNodeB (gNB), a radio resource control (RRC) message including at least one layer 1/layer 2 triggered mobility (LTM) candidate configuration, receive, from the gNB, a medium access control (MAC) control element (CE) associated with an LTM, identify that the LTM is triggered based on the MAC CE, and apply an LTM candidate configuration for the LTM in case that the LTM candidate configuration includes information indicating that the LTM candidate configuration is a complete configuration.

In accordance with another aspect of the disclosure, a central unit (CU) associated with a gNodeB (gNB) in a communication system is provided. The CU includes a transceiver, and at least one processor coupled to the transceiver and configured to transmit, to a distributed unit (DU) associated with the gNB, a context setup request message, receive, from the DU, a response message including at least one layer 1/layer 2 triggered mobility (LTM) candidate configuration as a response to the context setup request message, transmit, to a terminal, a radio resource control (RRC) message including the at least one LTM candidate configuration, and transmit, to the terminal, a medium access control (MAC) control element (CE) associated with an LTM, wherein an LTM candidate configuration for the LTM is applied in case that the LTM candidate configuration includes information indicating that the LTM candidate configuration is a complete configuration.

The disclosure provides various methods for managing the reference cell configuration for subsequent L1/L2 triggered mobility (LTM) proposed in the disclosure (L1/L2 signaling-triggered handover). Accordingly, the UE may receive a target candidate cell configuration for LTM and may decode and store the same.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a next-generation mobile communication system to which the disclosure is applicable.

FIG. 2 illustrates a radio protocol structure of a next-generation mobile communication system according to an embodiment of the disclosure;

FIG. 3 illustrates a structure of another next-generation mobile communication system according to an embodiment of the disclosure;

FIG. 4 illustrates a scenario regarding inter-cell beam management referred to in the disclosure, wherein a UE transmits/receives data through a beam of a transmission/reception point (TRP) of a neighbor cell which supports an L1/L2 -triggered beam change, while maintaining a state of connection to the serving cell according to an embodiment of the disclosure;

FIGS. 5A and 5B illustrate a scenario wherein a UE transmits/receives data after changing the serving cell and the beam to the TRP of a cell which supports an L1/L2-triggered beam change, according to various embodiments of the disclosure;

FIG. 6 illustrates a subsequent L1/L2-triggered handover (LTM) operation, which is performed based on a reference cell configuration, as an overall operation applied according to an embodiment of the disclosure;

FIG. 7 illustrates operations after a failed subsequent L1/L2-triggered handover (LTM) operation, which is performed based on a reference cell configuration, as an overall operation applied according to an embodiment of the disclosure;

FIG. 8 illustrates overall UE operations of performing L1/L2-triggered beam changes and handovers, applied according to an embodiment of the disclosure;

FIG. 9 illustrates gNB operations applied to according to an embodiment of the disclosure;

FIG. 10 is a block diagram illustrating the internal structure of a UE to which according to an embodiment of the disclosure; and

FIG. 11 is a block diagram illustrating the configuration of a gNB according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description of the disclosure, terms and names defined in the 3rd generation partnership project long term evolution (3GPP LTE) standards will be used for the sake of descriptive convenience. However, the disclosure is not limited by these terms and names, and may be applied in the same way to systems that conform other standards.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

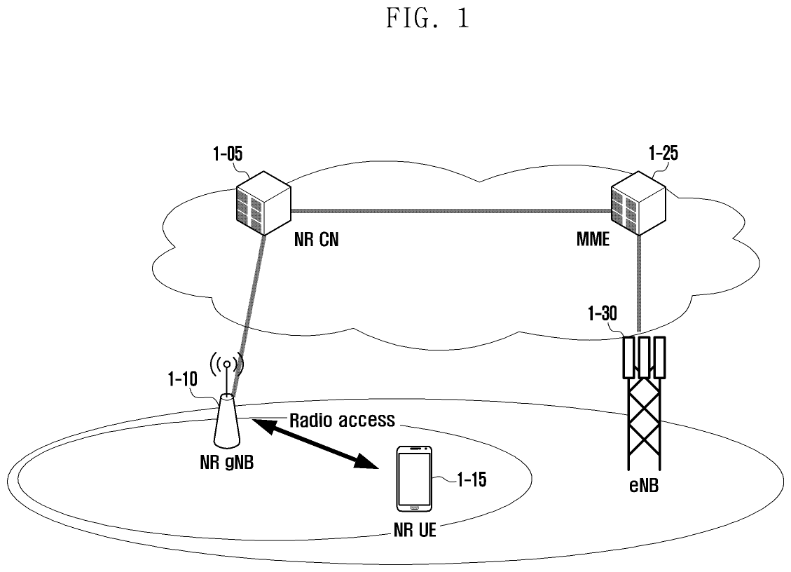

FIG. 1 illustrates a structure of a next-generation mobile communication system according to an embodiment of the disclosure.

Referring to FIG. 1, as illustrated therein, a radio access network of a next-generation mobile communication system includes a next-generation base station (new radio node B, hereinafter NR NB) 1-10, and a new radio core network (NR CN) or next generation core network (NG CN) 1-05. A user terminal (new radio user equipment, hereinafter NR UE or NR terminal) 1-15 accesses an external network via the NR NB 1-10 and the NR CN 1-05.

In FIG. 1, the NR NB 1-10 corresponds to an evolved node B (eNB) of a conventional LTE system. The NR NB 1-10 is connected to the NR UE 1-15 through a radio channel and may provide outstanding services as compared to a conventional node B. In the next-generation mobile communication system, since all user traffic is serviced through a shared channel, a device that collects state information, such as buffer statuses, available transmit power states, and channel states of UEs, and performs scheduling accordingly is required, and the NR NB 1-10 serves as the device. In general, one NR NB controls multiple cells. In order to implement ultrahigh-speed data transfer beyond the current LTE, the next-generation mobile communication system may provide a wider bandwidth than the existing maximum bandwidth, may employ an orthogonal frequency division multiplexing (hereinafter referred to as OFDM) as a radio access technology, and may additionally integrate a beamforming technology therewith. Furthermore, the next-generation mobile communication system employs an adaptive modulation & coding (hereinafter referred to as AMC) scheme for determining a modulation scheme and a channel coding rate according to a channel state of a UE. The NR CN 1-05 performs functions such as mobility support, bearer configuration, and QoS configuration. The NR CN is a device responsible for various control functions as well as a mobility management function for a UE, and is connected to multiple base stations. In addition, the next-generation mobile communication system may interwork with the existing LTE system, and the NR CN is connected to an MME 1-25 via a network interface. The MME is connected to an eNB 1-30 that is an existing base station.

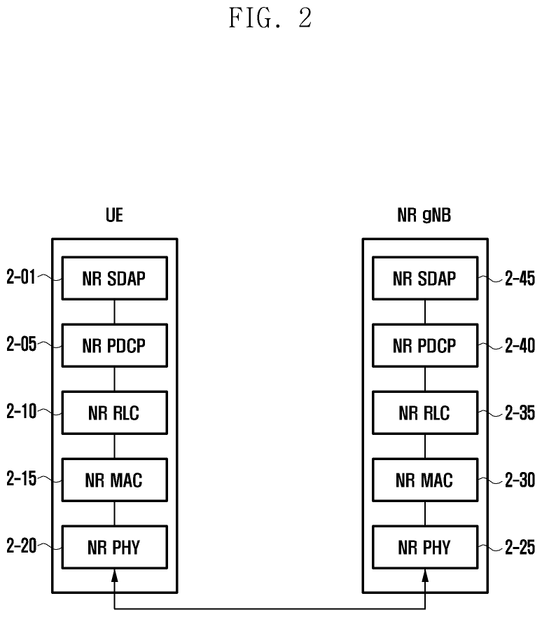

FIG. 2 illustrates a radio protocol structure of a next-generation mobile communication system according to an embodiment of the disclosure.

Referring to FIG. 2, a radio protocol of a next-generation mobile communication system includes an NR SDAP 2-01 or 2-45, an NR PDCP 2-05 or 2-40, an NR RLC 2-10 or 2-35, and an NR MAC 2-15 or 2-30 in each of a UE and an NR base station.

Major functions of the NR SDAPs 2-01 and 2-45 may include some of the following functions:
Transfer of user plane data
Mapping between a QoS flow and a DRB for both DL and UL
Marking QoS flow ID in both DL and UL packets
Reflective QoS flow to DRB mapping for UL SDAP PDUs

With regard to the SDAP layer device, the UE may be configured, through an RRC message, whether to use the header of the SDAP layer device with regard to each PDCP layer device or with regard to each bearer or with regard to each logical channel, or whether to use functions of the SDAP layer device. If an SDAP header is configured, the NAS QOS reflection configuration 1-bit indicator (NAS reflective QoS) of the SDAP header and the AS QoS reflection configuration 1-bit indicator (AS reflective QoS) thereof may be indicated such that the UE can update or reconfigure mapping information regarding the QoS flow and data bearer of the uplink and downlink. The SDAP header may include QoS flow ID information indicating the QoS. The QoS information may be used as data processing priority for providing efficient services, scheduling information, or the like.

Major functions of the NR PDCPs 2-05 and 2-40 may include some of the following functions:
Header compression and decompression: ROHC only
Transfer of user plane data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The reordering of the NR PDCP device refers to a function of reordering PDCP PDU received from a lower layer in an order based on PDCP sequence numbers (SNs), and may include a function of transferring data to a higher layer according to a rearranged order, may include a function of directly transferring data without considering order, may include a function of rearranging order to record lost PDCP PDUs, may include a function of reporting the state of lost PDCP PDUs to a transmission side, or may include a function of requesting retransmission of lost PDCP PDUs.

Major functions of the NR RLCs 2-10 and 2-35 may include some of the following functions:
Transfer of upper layer PDUs
In-sequence delivery of upper layer PDUs

Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery of the NR RLC device may indicate a function of transferring RLC SDUs received from a lower layer to a higher layer in sequence. Furthermore, the in-order delivery may include a function of, if one original RLC SDU is divided into several RLC SDUs and then the RLC SDUs are received, reassembling the several RLC SDUs and transferring the reassembled RLC SDUs, may include a function of rearranging received RLC PDUs with reference to RLC sequence numbers (SNs) or PDCP sequence numbers (SNs), may include a function of rearranging order to record lost RLC PDUs, may include a function of reporting the state of lost RLC PDUs to a transmission side, may include a function of requesting retransmission of lost RLC PDUs, may include a function of, if there is a lost RLC SDU, sequentially transferring only RLC SDUs before the lost RLC SDU to a higher layer, may include a function of, although there is a lost RLC SDU, if a predetermined timer has expired, sequentially transferring, to a higher layer, all the RLC SDUs received before the timer is started, or may include a function of, although there is a lost RLC SDU, if a predetermined timer has expired, sequentially transferring all the RLC SDUs received up to the current, to a higher layer. In addition, the RLC PDUs may be processed in the received order (regardless of the sequence number order, in the order of arrival) and delivered to the PDCP device regardless of the order (out-of-sequence delivery). In the case of segments, segments which are stored in a buffer, or which are to be received later, may be received, reconfigured into one complete RLC PDU, processed, and delivered to the PDCP device. The NR RLC layer may include no concatenation function, which may be performed in the NR MAC layer or replaced with a multiplexing function of the NR MAC layer.

The out-of-sequence delivery function of the NR RLC device refers to a function of instantly delivering RLC SDUs received from the lower layer to the upper layer regardless of the order, may include a function of reassembling and delivering multiple RLC SDUs received, into which one original RLC SDU has been segmented, and may include a function of storing the RLC SN or PDCP SN of received RLC PDUs, and recording RLC PDUs lost as a result of reordering.

The NR MAC 2-15 or 2-30 may be connected to several NR RLC layer devices configured in a single UE, and major functions of the NR MAC may include some of the following functions:
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

An NR PHY layer 2-20 or 2-25 may perform channel coding and modulation of higher layer data to make the data into OFDM symbols and transmit the OFDM symbols through a wireless channel, or may perform demodulation and channel decoding of OFDM symbols received through a wireless channel, and then transfer the OFDM symbols to a higher layer.

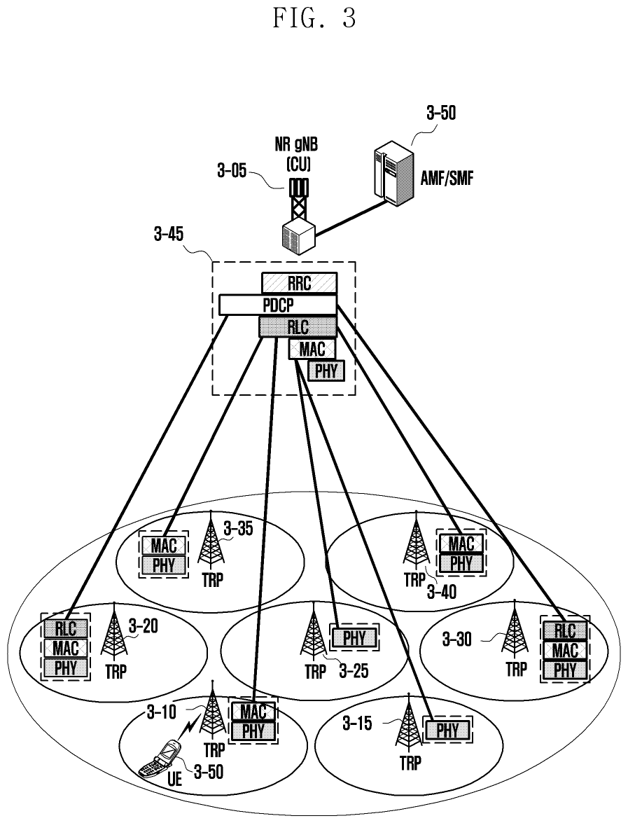

FIG. 3 illustrates a structure of another next-generation mobile communication system according to an embodiment of the disclosure.

Referring to FIG. 3, the cell serviced by the NR gNB 3-05 which operates based on beams may include multiple transmission reception points (TRPs) 3-10, 3-15, 3-20, 3-25, 3-30, 3-35, and 3-40. The TRPs 3-10 to 3-40 refer to blocks from which some functions for transmitting/receiving physical signals are separated in a legacy NR eNB, and include multiple antennas. The NR gNB 3-05 may also be referred to as a central unit (CU), and TRPs may also be referred to as distributed units (DUs). Functions of the NR gNB 3-05 and the TRPs may be configured by separating respective layers in PDCP/RLC/MAC/PHY layers such as 3-45. That is, the TRPs may have the PHY layer only and perform functions of the corresponding layer (3-15 and 3-25), or the TRPs may have the PHY layer and the MAC layer only and perform functions of the corresponding layers (3-10, 3-35, and 3-40), and the TRPs may have the PHY layer, the MAC layer, and the RLC layer only and perform functions of the corresponding layers (3-2 and 3-30). Particularly, the TRPs 3-10 and 3-40 may use multiple transmission/reception antennas so as to generate narrow beams in various directions, thereby transmitting/receiving data (beamforming technology). The UE 3-50 accesses the NR gNB 3-05 and external networks through the TRPs 3-10 to 3-40. The NR gNB 3-05 aggregates and schedules state information, such as UEs' buffer state, available transmission power state, and channel state, in order to provide services to users, thereby supporting connection between the UEs and the core network (CN), particularly AMF/SMF 3-50.

The TRPs in the disclosure basically have structures 3-15 and 3-25 in which the same may have the PHY layer only and perform functions of the corresponding layer.

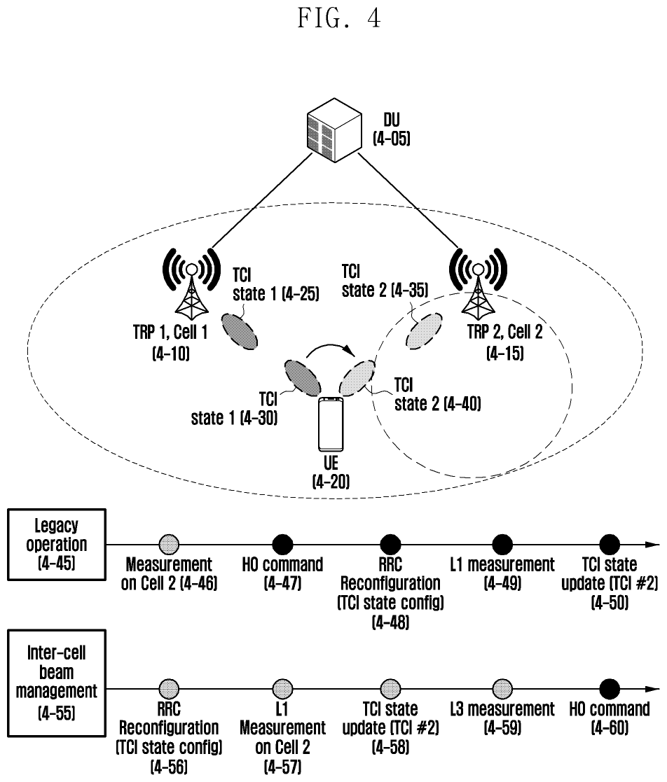

FIG. 4 illustrates a scenario regarding inter-cell beam management referred to in the disclosure, wherein a UE transmits/receives data through a beam of a transmission/reception point (TRP) of a neighbor cell which supports an L1/L2 -triggered beam change, while maintaining a state of connection to the serving cell according to an embodiment of the disclosure.

Referring to FIG. 4, a case in which multiple cells (TRP1-Cell1 and TRP2-Cell2) 4-10 and 4-15 exist in one distributed unit (DU) 4-05, the overall content of the disclosure is also applicable to the case of inter-DU (each DU constitutes one TRP-Cell). In addition, throughout the disclosure, a non-serving cell TRP 2 or Cell 2 which supports L1/L2-triggered mobility (LTM) (beam change and serving cell change) will be used interchangeably with a neighbor cell, a non-serving cell, an additional cell having a different PCI from the serving cell, and the like.

According to the legacy UE beam change procedure 4-45, the UE 4-20 may transmit/receive data in a connected state through the TRP 1 4-10 of serving cell 1, and the beam used by the UE to transmit/receive data may be coordinated with TCI state 1 4-25 and 4-30 as an optimal beam. In addition, the UE may receive, from the serving cell 4-10, configuration information for L3 channel measurement (radio resource management (RRM)) regarding an additional cell TRP 2-Cell 2 4-15 having a different PCI from the serving cell through RRC configuration information, and the UE performs an L3 measurement operation 4-46 regarding the corresponding frequency and cell. In addition, the serving cell TRP 1-Cell 1 4-10 may indicate a handover (4-47) to the corresponding cell TRP 2-Cell 2 4-15, based on the reported measurement value. In addition, after the handover is completed, additional RRC configuration information may be delivered (4-48) to the UE 4-20 through the TRP 2-Cell 2 4-15. The RRC configuration information may include at least one of UL/DL configuration information in the corresponding cell, and L1 measurement-related configuration (CSI-RS measurement and reporting) and, particularly, may include TCI state configuration information for PDCCH and PDSCH channels. The UE performs L1 measurement according to the configuration (4-49), and the gNB updates the TCI state through L1/L2 signaling according to the measurement report (4-50). Through the TCI state update, TCI state 2 4-40 (optimal beam) may be indicated. Before the handover, Cell1 is the serving cell, and after the handover, Cell 2 is the serving cell. Therefore, many procedures and a long time are necessary to indicate the optimal beam, even after the handover.

An improved beam change technique 4-55 considered in the disclosure, which is different from the legacy UE beam change procedure 4-45, is as follows. The UE may receive RRC configuration information 4-56 from the serving cell 4-10. The serving cell may deliver a beam configuration related to the additional cell TRP 2-Cell 2 4-15 having a different PCI from the serving cell to the UE through the RRC configuration information. As a method for configuring the beam configuration related to the additional cell TRP 2-Cell 2 4-15 having a different PCI from the serving cell, that is, configuring the TCI state corresponding to TRP2, a new physical cell ID (PCI) (additionalPCI-r17) is indicated in association with the TCI state, as follows:

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, -- Need R |

```
  ...,
  [[
```

| | | |
|---|---|---|
| additionalPCI-r17 | AdditionalPCIIndex-r17 | OPTIONAL, -- Need R |
| pathlossReferenceRS-Id-r17 | PUSCH-PathlossReferenceRS-Id | OPTIONAL, -- Cond JointTCI |
| ul-powerControl-r17 | Uplink-powerControlId-r17 | OPTIONAL Cond JointTCI |

]]
}

In addition, for the corresponding inter-cell beam management, a unified TCI state framework is applied. According to the unified TCI state framework, a common TCI state framework is applied in the uplink, downlink, common channel, and dedicated channel, and one of a joint UL/DL mode and a separate UL/DL mode may be configured therefor.

| | |
|---|---|
| additionalPCI-ToAddModList-r17 | SEQUENCE (SIZE(1..maxNrofAdditionalPCI-r17)) OF SSB-MTC-AdditionalPCI-r17 |

| | |
|---|---|
| OPTIONAL, | -- Need N |

| | |
|---|---|
| additionalPCI-ToReleaseList-r17 | SEQUENCE (SIZE(1..maxNrofAdditionalPCI-r17)) OF AdditionalPCIIndex-r17 |

| | |
|---|---|
| OPTIONAL, | -- Need N |

| | |
|---|---|
| unifiedTCI-StateType-r17 | ENUMERATED {separate, joint} OPTIONAL, |

-- Need R

| | |
|---|---|
| uplink-PowerControlToAddModList-r17 | SEQUENCE (SIZE (1..maxUL-TCI-r17)) OF Uplink-powerControl-r17 |

| | |
|---|---|
| OPTIONAL, | -- Need N |

| | |
|---|---|
| uplink-PowerControlToReleaseList-r17 | SEQUENCE (SIZE (1..maxUL-TCI-r17)) OF Uplink-powerControlId-r17 |

| | |
|---|---|
| OPTIONAL, | -- Need N |

| | |
|---|---|
| sfnSchemaPDCCH-r17 | ENUMERATED {sfnSchemeA,sfnSchemeB} |

| | |
|---|---|
| OPTIONAL, | -- Need R |

| | |
|---|---|
| sfnSchemePDSCH-r17 | ENUMERATED {sfnSchemeA,sfnSchemeB} |

| | |
|---|---|
| OPTIONAL | -- Need R |

}

1. Joint UL/DL mode: the UL and DL are both configured to share the same TCI configuration (in PDSCH-Config)

| | |
|---|---|
| dl-OrJoint-TCIStateList-r17 | CHOICE { |
| explicitlist | SEQUENCE { |
| dl-orJoint-TCI-State-ToAddModList-r17 | SEQUENCE (SIZE (1..maxNrofTCI-States)) OF TCI-State |
| | OPTIONAL, -- Need N |
| dl-orJoint-TCI-State-ToReleaseList-r17 | SEQUENCE (SIZE (1..maxNrofTCI-States)) OF TCI-StateId |
| | OPTIONAL -- Need N |

},

| | |
|---|---|
| unifiedTCI-StateRef-r17 | ServingCellAndBWP-Id-r17 |

}

2. Separate UL/DL mode: the UL and DL are provided with respective TCI configurations. The TCI state regarding the DL follows configurations in dl-OrJoint-TCIStateList-r17 (in PDSCH-Config), and the TCI state regarding the UL follows ul-TCI-StateList-r17 (in BWP-UplinkDedicated).

| | |
|---|---|
| ul-TCI-StateList-r17 | CHOICE { |
| explicitlist | SEQUENCE { |
| ul-TCI-ToAddModList-r17 | SEQUENCE (SIZE (1..maxUL-TCI-r17)) OF TCI-UL-State-r17 |

OPTIONAL, -- Need N

| | |
|---|---|
| ul-TCI-ToReleaseList-r17 | SEQUENCE (SIZE (1..maxUL-TCI-r17)) OF TCI-UL-State-Id-r17 |

OPTIONAL -- Need N
},

| | |
|---|---|
| unifiedTCI-StateRef-r17 | ServingCellAndBWP-Id-r17 |

} OPTIONAL, -- Need R

After the configuration regarding the TRP 2-Cell 2 is provided to the UE while the UE remains RRC-connected to serving cell 1, the UE performs L1 measurement regarding the TRP 2-Cell 2 according to the configuration, and reports the corresponding result to the serving cell (Cell 1) 4-10 (4-57). If the serving cell determines, based on the measurement result, that a change is necessary from the serving cell beam (TCI state 1) 4-25 and 4-30 to a specific beam (TCI state 2) 4-35 and 4-40 of TRP2 (Cell 2) 4-15, the serving cell may trigger a beam change and may indicate the beam change to the UE through L1/L2 signaling (4-58). The UE makes a beam change to a specific beam (TCI state 2) 4-40 of TRP 2 (Cell 2) 4-15 according to the indication, and perform an operation of configuring an upper layer and a physical channel related to the configured beam. The UE remains connected to the serving cell (Cell 1) 4-10 from the corresponding step, but transmits/receives data by using a channel link of TRP 2 (Cell 2) 4-15 (PDCCH/PDSCH reception, PUCCH/PUSCH transmission). That is, transmission/reception regarding the common control channel is performed through the serving cell (Cell 1) 4-10. There UE may then perform an L3 measurement operation according to the measurement configuration configured in an independent serving cell (4-59), may receive a handover command message from the serving gNB (Cell 1), and may perform a serving cell change to Cell 2 (4-60). Through this technique 4-55, the UE may transmit/receive data with specific TRP 2 of Cell2 which supports L1/L2-triggered mobility while being connected to the serving cell, and may continuously use the corresponding beam even after the handover.

In addition, RRC configurations regarding operations and configurations related to L1 measurement and report in operation 4-57 above will now be described. The corresponding content is basically applied in following embodiments of the disclosure as well, and improved techniques may be added in following embodiments.

1. CSI measurement configuration
Measurement-requiring CSI-RS resources and resource pools (nzp-CSI-RS, csi-IM, csi-SSB)
Measurement-requiring CSI-RS resource configuration (aperiodic, semi-persistent) and triggering configuration
If CSI-RS resources refer to SSB resources, additional PCI information is provided such that L1 measurement from neighbor cells is possible (a maximum of seven neighbor cells (PCI) can be added in one serving cell)

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB-ResourcePerSet)) OF SSB-Index, |

```
  ...,
  [[
```

| | |
|---|---|
| servingAdditionalPCIList-r17 | SEQUENCE (SIZE(1..maxNrofCSI-SSB-ResourcePerSet)) OF |

| | |
|---|---|
| ServingAdditionalPCIIndex-r17 | OPTIONAL -- Need R |

]]
}

| | | |
|---|---|---|
| ServingAdditionalPCIIndex-r17 | ::= | INTEGER(0..maxNrofAdditionalPCI-r17) |

| | |
|---|---|
| SSB-MTC-AdditionalPCI-r17 ::= | SEQUENCE { |
| additionalPCIIndex-r17 | AdditionalPCIIndex-r17, |
| additionalPCI-r17 | PhysCellId, |
| periodicity-r17 | ENUMERATED { ms5, ms10, ms20, ms40, ms80, ms160, spare2, spare1 }, |
| ssb-PositionsInBurst-r17 | CHOICE { |
| shortBitmap | BIT STRING (SIZE (4)), |
| mediumBitmap | BIT STRING (SIZE (8)), |
| longBitmap | BIT STRING (SIZE (64)) |

},

| | |
|---|---|
| ss-PBCH-BlockPower-r17 | INTEGER (−60..50) |

}

2. CSI report configuration
Report type: periodic, semi-persistent for PUCCH, semi-persistent for PUSCH, aperiodic for PUSCH
Report quantity
Other configurations necessary for reporting

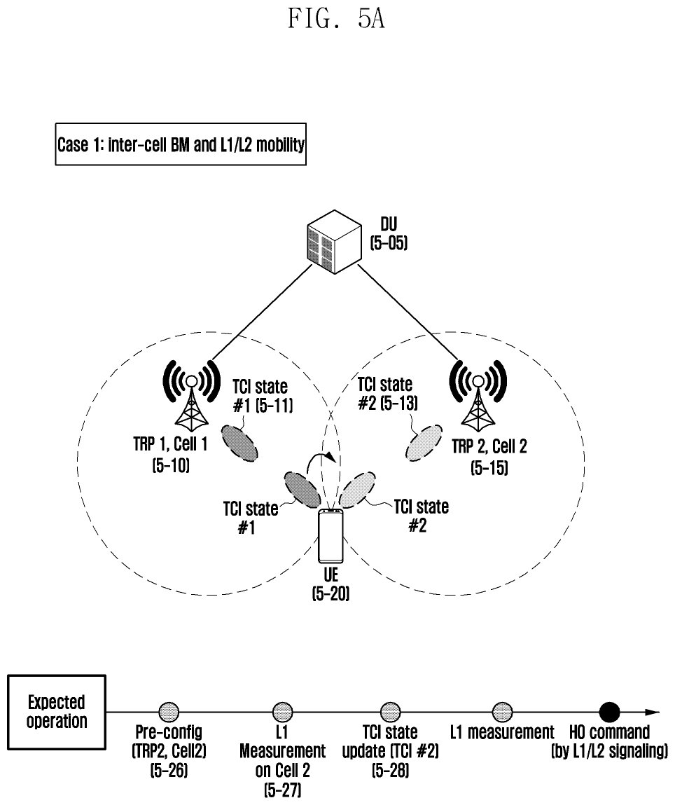

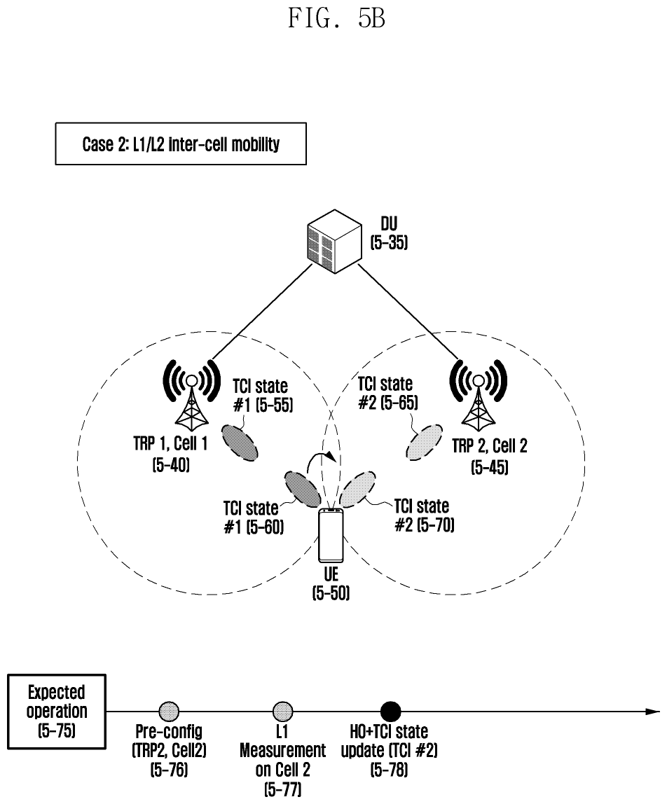

FIGS. 5A and 5B illustrates a scenario wherein a UE 5-20 or 5-50 transmits/receives data after changing the serving cell and the beam to the TRP of a cell which supports an L1/L2-triggered beam change, according to various embodiments of the disclosure.

Referring to FIGS. 5A and 5B, a case in which multiple cells (TRP1-Cell1 and TRP2-Cell2) 5-10, 5-15, 5-40, and 5-45 exist in one distributed unit (DU) 5-05 or 5-35, the overall content of the disclosure is also applicable to the case of inter-DU (each DU constitutes one TRP-Cell).

Improved beam change techniques 5-25 and 5-75 considered in the embodiments, which are different from the legacy UE beam change procedures 4-45 and 4-55 described with reference to FIG. 4, are as follows:
1. Embodiment 1 5-25: an inter-cell beam management (change) operation is performed, and an L1/L2 handover is then performed
2. Embodiment 2 5-75: L1/L2 handover is instantly performed

To describe the entire operation of embodiment 1, the UE 5-20 may receive information about common configurations and dedicated configurations regarding an additional cell TRP 2-Cell 2 5-15 having a different PCI from the serving cell through RRC configuration information from the serving cell 5-10 (5-26). That is, configuration information corresponding to ServingCellID or candidateCellID (PCI-related cell ID), ServingCellConfigCommon, and ServingCellConfig may be provided to the UE. The configuration information may be provided in a pre-configuration type in the RRC configuration, and may include configuration information regarding multiple cells. In addition, the configurations are characterized by including configuration information applied when the UE moves (hands over) to the corresponding cell (at least one of cell configuration, bearer configuration, measurement-related configuration, and security key configuration). The configurations may also include the unified TCI state configuration and configurations related to L1 measurement and report, described in relation to operation 4-56 in FIG. 4. In the embodiment, a method for pre-providing configurations regarding candidate neighbor cells in which L1/L2 handovers may be performed, particularly, a method for configuring cell group configurations (CellGroupConfig) including cell configurations, radio bearer configurations (RadioBearerConfig), and L3 measurement-related configurations (MeasConfig), will be described in detail. In addition, the embodiment considered a method wherein, when the above configuration information is delivered to the UE, the same can be delivered more efficiently than when specific configuration information of specific LTM candidate cells is solely updated. Moreover, the embodiment also proposes a method wherein, if RLC bearer configurations, logical channel configurations, MAC configurations and the like are generally applicable even inside cell group configurations, these are configured effectively to reduce signaling overhead. In addition, the embodiment specifies the above-mentioned solutions by considering not only intra-CU, but also inter-CU scenarios.

Configurations regarding the TRP 2-Cell 2 5-15 are provided to the UE while the UE maintains RRC connection to serving cell 1, and the UE performs L1 measurement regarding the TRP 2-Cell 2 5-15, based on the configurations, in operation 5-27, and reports the result to the serving cell (Cell 1) 5-10. If the serving cell determines, based on the measurement result, that a change is necessary from the serving cell beam (TCI state 1) 5-11 to a specific beam (TCI state 2) 5-13 of TRP2 (Cell 2) 5-15, the serving cell may trigger a beam change in operation 5-28 and may indicate the beam change to the UE through L1/L2 signaling. The UE makes a beam change to TRP 2 (Cell 2) 5-15 according to the indication, and transmits/receives data through the TRP 2 (Cell 2) 5-15. The serving cell is not changed in this case, and the UE is RRC-connected to the serving cell (Cell 1) 5-10. Thereafter, the UE still performs L1 measurement regarding TRP 2-Cell 2 5-15 and reports the result to the serving cell (Cell 1) 5-10. If the L1 measurement 5-29 reported by the UE satisfies a triggering condition for a handover to TRP 2-Cell 2 5-15 (detailed operations will be described later), the serving cell (Cell 1) 5-10 instructs the UE to hand over in operation 5-30. The instruction may be made through an L1/L2 message. That is, the MAC CE or DCI may include a handover indicator.

To describe the entire operation of embodiment 2, the UE may receive information about common configurations and dedicated configurations regarding an additional cell TRP 2-Cell 2 5-45 having a different PCI from the serving cell through RRC configuration information from the serving cell 5-40 (5-76). That is, configuration information corresponding to ServingCellID or candidateCellID (PCI-related cell ID), ServingCellConfigCommon, and ServingCellConfig may be provided to the UE. The cell-related configuration information may be related to cell group level configurations (CellGroupConfig), not cell-level configurations, or RRC configuration message (RRCReconfiguration)-based configurations.

The configuration information may be provided in a pre-configuration type in the RRC configuration, and may include configuration information regarding multiple cells. In addition, the configuration is characterized by including configuration information applied when the UE moves (hands over) to the corresponding cell (at least one of cell configuration, bearer configuration, and security key configuration). The configurations may also include the unified TCI state configuration and configurations related to L1 measurement and report, described in relation to operation 4-56 in FIG. 4. In the embodiment, a method for pre-providing configurations regarding candidate neighbor cells in which L1/L2 handovers may be performed, particularly, a method for providing configuration information regarding reference cells as configurations regarding candidate neighbor cells and applying a delta configuration, will be described in detail.

After configurations regarding the TRP 2-Cell 2 5-45 are provided to the UE 5-50 while the UE maintains RRC connection to serving cell 1, the UE performs L1 measurement regarding the TRP 2-Cell 2 5-45 according to the configurations in operation 5-77, and reports the result to the serving cell (Cell 1) 5-40. If the serving cell determines, based on the measurement result, that a handover is necessary concurrently with a beam change from the serving cell beam (TCI state 1) 5-55 and 5-60 to a specific beam (TCI state 2) 5-65 and 5-70 of TRP2 (Cell 2) 5-45, the serving cell may trigger a beam change and a handover in operation 5-78 and may indicate the beam change to the UE through L1/L2 signaling. The UE performs a handover concurrently with a beam change to TRP 2 (Cell 2) 5-15 according to the indication, and transmits/receives data through the TRP 2 (Cell 2) 5-15. In this regard, the UE applies configuration information regarding the target cell to which a handover is to be performed, preconfigured in operation 5-76. The UE may perform random access according to whether uplink synchronization needs to be made in the corresponding step, and random access to the target cell may be omitted. Detailed operations will hereinafter be described with reference to the drawings.

In following embodiments of the disclosure, all descriptions will be made with reference to drawings related to intra-CU, but all operations proposed in the disclosure are expandable to inter-CU. That is, embodiments of the disclosure are applicable to cases wherein candidate cells to which LTM is applied exist in other CUs. However, the difference in the case of inter-CU is the need for an interface procedure (Xn and inter-node RRC message) which requires additional message exchanges between CUs. For reference, such a procedure is omitted in an intra-CU situation.

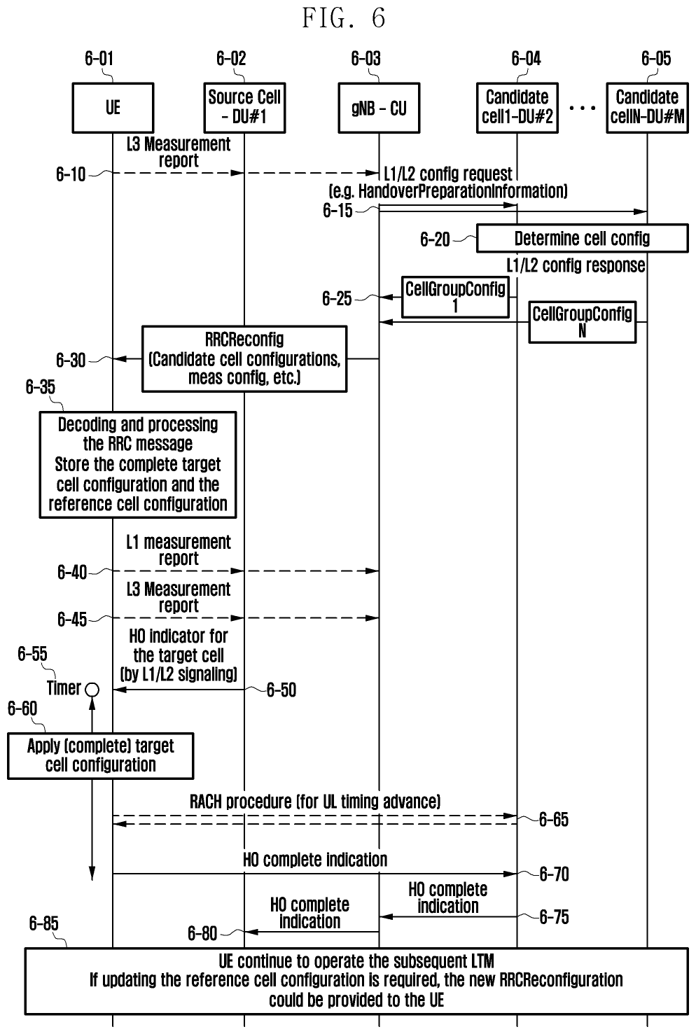

FIG. 6 illustrates a subsequent L1/L2-triggered handover (LTM) operation, which is performed based on a reference cell configuration, as an overall operation applied according to an embodiment of the disclosure.

The UE 6-01 in an RRC-connected state may perform data transmission/reception with source cell 6-02. In addition, in operation 6-10, the UE 6-01 transmits a layer 3 measurement value regarding the serving cell and neighbor cells to source cell 1 6-02 according to configured layer 3 measurement and reporting. The measurement value is delivered to the CU 6-03 of the gNB. This is because the gNB CU 6-03 handles RRC message processing and determines mobility.

The gNB CU 6-03 may deliver a message (L1/L2 config request message or HandoverPreparationInformation message or new message) requesting configuration information for an L1/L2-triggered handover to LTM candidate neighbor cells 6-04 and 6-05 through an F1 interface in operation 6-15 according to the measurement value received from the UE. The F1 interface may refer to the interface between the CU and the candidate cell DU. Although candidate cells are illustrated in FIG. 6 in relation to DUs, candidate cells and DUs may actually have 1:1 mapping, or multiple candidate cells may be included on one DU. In addition, the message requesting configuration information for an L1/L2-triggered handover may be a legacy handover request message, a UE context request message, a UE context modification request message, or the like, or may be a new F1 or Xn message. Through the message requesting configuration information for an L1/L2-triggered handover, the gNB CU 6-03 informs neighbor cells that they are determined as L1/L2-triggered handover candidate cells, and request RRC configuration information which is to be applied when an L1/L2 -triggered handover is performed to a corresponding cell. The source gNB CU 6-03 may deliver reference cell configuration information, which is separate from source cell configuration information, while being included in the message. As an example, if a HandoverPreparationInformation is used, the HandoverPreparationInformation may have the following structure such that separate reference cell configuration information can be added to the legacy message to make a request. Detailed description of the ASN.1 structure will be omitted herein, but even if other messages are used, messages including the above-mentioned information may be generated and delivered to candidate cells.

| HandoverPreparationInformation-IEs ::= | SEQUENCE { | |
|---|---|---|
| ue-CapabilityRAT-List | UE-CapabilityRAT-ContainerList, | |
| sourceConfig | AS-Config | OPTIONAL, -- Cond HO |
| rrm-Config | RRM-Config | OPTIONAL, |
| as-Context | AS-Context | OPTIONAL, |
| nonCriticalExtension | SEQUENCE { } | OPTIONAL |

}
HandoverPreparationInformation-r18-IEs
{

| | | |
|---|---|---|
| refCellConfig | OCTET STRING (CONTAINING RRCReconfiguration) | OPTIONAL, |
| nonCriticalExtension | SEQUENCE { } | OPTIONAL |

}

The reference cell configuration information delivered from the source gNB CU 6-03 to respective candidate cells 6-04 and 6-05 may be a common configuration which may be commonly applied to multiple target candidate cells in order to reduce signaling overhead when the target candidate cells provide configuration information for LTM. The reference cell configuration information may include a measurement configuration, a bearer configuration, or in the case of cells belonging to the same CellGroup, at least one of configurations configured at the CellGroup level (for example, MAC-CellGroupConfig, RLC bearer configuration, SCell configuration, and the like). Alternatively, if the source gNB CU 6-03 knows configuration information for respective candidate cells 6-04 and 6-05 or there is a procedure through which the source gNB CU 6-03 obtain the configuration information regarding respective candidate cells 6-04 and 6-05, reference cell configuration information may be determined through the procedure. The purpose of the source gNB CU 6-03 delivering reference cell configuration information to respective candidate cells 6-04 and 6-05 is that respective candidate cells transmits only configuration information added with reference to the reference cell configuration to the source gNB CU 6-03 to apply delta configuration (a method wherein a complete configuration is configured by applying a configuration information for the candidate cell on top of the reference cell configuration, or a method wherein a complete configuration is configured by overwriting configuration information for the target cell with reference to the reference cell configuration). The information is also delivered to the UE, thereby advantageously reducing the signaling of the RRC message delivered to the UE.

In addition, when the source gNB CU 6-03 delivers the reference cell configuration to respective candidate cells 6-04 and 6-05, there is a need to accurately define whether the configuration is to be delivered always or is omissible, and if omissible, what operation is meant thereby. Hereinafter, various options are proposed regarding what operation is meant by the source gNB CU 6-03 omitting the reference cell configuration with regard to respective candidate cells 6-04 and 6-05.
1. First reference cell configuration omitting method: the target cell (DU) determines that there is no reference cell configuration, determines complete configuration information to be applied to the UE after LTM in operation 6-20, and delivers the complete configuration information to the source gNB CU 6-03 in operation 6-25. That is, the delta configuration is not applied.
2. Second reference cell configuration omitting method: the target cell (DU) determines that configuration information in the current source cell, provided by the source gNB CU 6-03, is reference cell configuration information, determines target candidate cell configuration information to which the delta configuration is to be applied with reference to the corresponding configuration in operation 6-20, and delivers the same to the source gNB CU 6-03 in operation 6-25.
3. Third reference cell configuration omitting method: when the source gNB CU 6-03 requests the candidate cells 6-04 and 6-05 to configure LTM in operation 6-15, an indicator indicating the “first reference cell configuration omitting method” or the “second reference cell configuration omitting method” may be transmitted. Therefore, the above-described reference cell configuration omitting method may be applied according to the indicator.

RRC configuration information (CellGroupConfig 1, . . . , CellGroupConfig N) applied when an L1/L2-triggered handover is performed may be delivered at one of a cell group level or an RRC message level. As described above, configurations for the reference cell may be delivered through the message 6-15 requesting an L1/L2-triggered handover. Alternatively, the message may include at least one of reference cell configuration information or an indicator indicating that configuration information for an L1/L2-triggered handover is to be configured by using the delta configuration. The indicator may be requested with regard to each cell or requested commonly with regard to all cells.

According to the above-described method, after receiving the message requesting an L1/L2-triggered handover, the candidate neighbor cells 6-04 and 6-05 may determine configuration information of respective candidate neighbor cells based on the L1/L2-triggered handover, based on configuration information of the reference cell, in operation 6-20. Configuration information of the candidate neighbor cells may be determined based on the delta configuration, or determined without applying the delta configuration. Thereafter, respective candidate neighbor cells 6-04 and 6-05 insert the generated configuration information for an L1/L2-triggered handover into a configuration information response message for an L1/L2-triggered handover (L1/L2 config response message) and transmits the response message to the gNB CU 6-03 in operation 6-25.

In step 6-30, the source cell 6-02 receives the RRC message generated by the gNB CU 6-03, based on configuration information received from respective candidate cells, and transmits the RRC message to the UE. The RRC message contains configuration information (Pre-Config1, . . . , Pre-ConfigN) regarding neighbor candidate cells to which an L1/L2-triggered handover (LTM) is applied. The Pre-Config included in the message including at least one of a CellGroupConfig configuration received from LTM candidate cells in operation 6-25, a bearer configuration regarding LTM candidate cells generated in the gNB, and a layer 3 (L3) measurement configuration.

Upon receiving an RRC message, the UE performs a procedure of decoding and processing the RRC message in operation 6-35. The processing includes methods for ASN.1 decoding of the received message, validity assessment thereof, storage/management of configuration content, and the like. In addition, the UE may store LTM configuration information regarding respective candidate cells, decoded in operation 6-35, in the buffer (memory) of the UE as complete configuration information, and may also store reference cell configuration information received concurrently therewith in the buffer (memory) of the UE together.

In addition, the RRC message (or configuration information regarding respective LTM candidate cells) in operation 6-30 may include an indicator (no_reference eunumerated {true}) indicating whether reference cell configuration information is provided together. Alternatively, reference cell configuration information may be omitted (or not included) in the RRC message (or configuration information regarding respective LTM candidate cells) in operation 6-30. In this case, the UE may perform operations as follows:
1. First UE operation: if the RRC message includes no reference cell configuration information, the UE determines that received configuration information regarding LTM target candidate cells is complete configuration information, and stores the configuration information. The UE does not separately store reference cell configuration information (operates assuming that the reference cell configuration information is empty). That is, no delta configuration is applied.
2. Second UE operation: the UE may be aware that reference cell configuration information is the current source cell's configuration information. The UE determines that received configuration information regarding LTM target candidate cells is complete configuration information by applying the delta configuration to the reference cell configuration information (source cell's configuration), and stores the information. In this case, current source cell configuration information may be explicitly provided to the UE, or the UE may implicitly know the source cell configuration information without an explicit configuration. This may follow rules in standards regarding what common configuration information is applied to the reference cell configuration, or separately distinguished common configuration information may be used.

In operation 6-40, the UE may perform L1 (layer 1) measurement and reporting the measurement result with regard to respective candidate neighbor cells. In operation 6-45, the UE may perform L3 measurement and reporting the measurement result according to configurations.

Upon receiving the L1 measurement report, the source cell may determine a handover, based on the received measurement value, and indicates an L1/L2 handover to the UE in operation 6-50. In the above step, a MAC CE including a handover indicator and DCI may be used for L1/L2 signaling.

In operations 6-40 and 6-50, the source cell (DU) or source gNB CU may receive a measurement value for determining an L1/L2-triggered handover and then determine a handover. If the gNB CU makes all determinations, the source cell delivers an L1 measurement value received from the UE, and delivers L1/L2 signaling to the UE according to the source gNB CU's handover determination indication. However, if the source cell makes the handover determination, the source cell delivers no L1 measurement value to the gNB, determines a handover according to a measurement value reference (threshold value and measurement value ranges) for a handover regarding respective candidate neighbor cells received from the previous gNB, and accordingly delivers L1/L2 signaling to the UE.

After the L1/L2 handover indication is delivered to the UE, the UE performs a handover procedure in operation 6-55, and starts a timer for an L1/L2 handover. The timer may be a timer newly configured for LTM, or a legacy T304 timer may be used again.

In operation 6-60, the UE applies configurations regarding the target cell to which an L1/L2 handover is applied. That is, the current configuration is replaced with complete configuration information of the indicated LTM target cell prestored in the UE. This is one of LTM candidate neighbor cell configurations received in advance in operation 6-30, and is a configuration stored in the UE. In operation 6-65, the UE may perform random access if random access is necessary with regard to the target cell according to the configuration applied to the UE. However, the random access procedure will be omitted if no random access is indicated or needed (if uplink synchronization has already been performed or made).

In operation 6-70, the UE performs a handover completion procedure with the target cell. The completion procedure may be an LTM-related handover completion procedure. The procedure may vary depending on the handover completion indicating method. Specifically, the handover completion procedure may be a process of transmitting an RRCReconfigurationComplete message if the target cell's configuration has been received through an RRC message, and may be a procedure or transmitting a new handover completion indication message (new RRC message or MAC CE) if a cell-level or cell group-level configuration has been received.

In addition, since the present scenario considers application to intra-CU, after receiving a handover completion message, the target cell (DU) 6-04 may deliver the handover completion message to the gNB CU 6-03 in operation 6-75. The target cell (DU) 6-04 may deliver the received handover completion message through the F1 interface without processing the same, or may newly generate a message, based on received information, and deliver the same. Thereafter, in operation 6-80, the gNB CU 6-03 may deliver information regarding handover completion to the source cell 6-02 and instruct the same to release the UE context.

In addition, as will be described in operation 6-85, embodiments of the disclosure support a subsequent LTM operation. This means that the UE keeps performing the LTM procedure unless the LTM configuration information (at least one of the configuration regarding target candidate cells or reference cell configuration information) received by the UE in operation 6-30 is stored in the UE such that the LTM configuration information is changed/released/added through a separate RRC configuration. If the reference cell configuration information needs to be updated, new RRC configuration information may be delivered to the UE. That is, the procedure described with reference to FIG. 6 may be triggered and performed again.

To summarize, upon receiving reference cell configuration information in operation 6-30, the UE may store the same in the UE buffer, and if there is no separate configuration-related update, the UE may continuously use the corresponding configuration as reference cell configuration information even after performing LTM (operation 6-50) (that is, the stored reference cell configuration and LTM candidate configuration values are applied to subsequent LTM). In addition, if no reference cell configuration information has been received in the RRC-connected state in operation 6-30, the reference cell configuration may be released and stored according to the UE operation option described above, or configuration information regarding the corresponding source cell (PCell) from which LTM configuration information was received may be stored as reference cell configuration information.

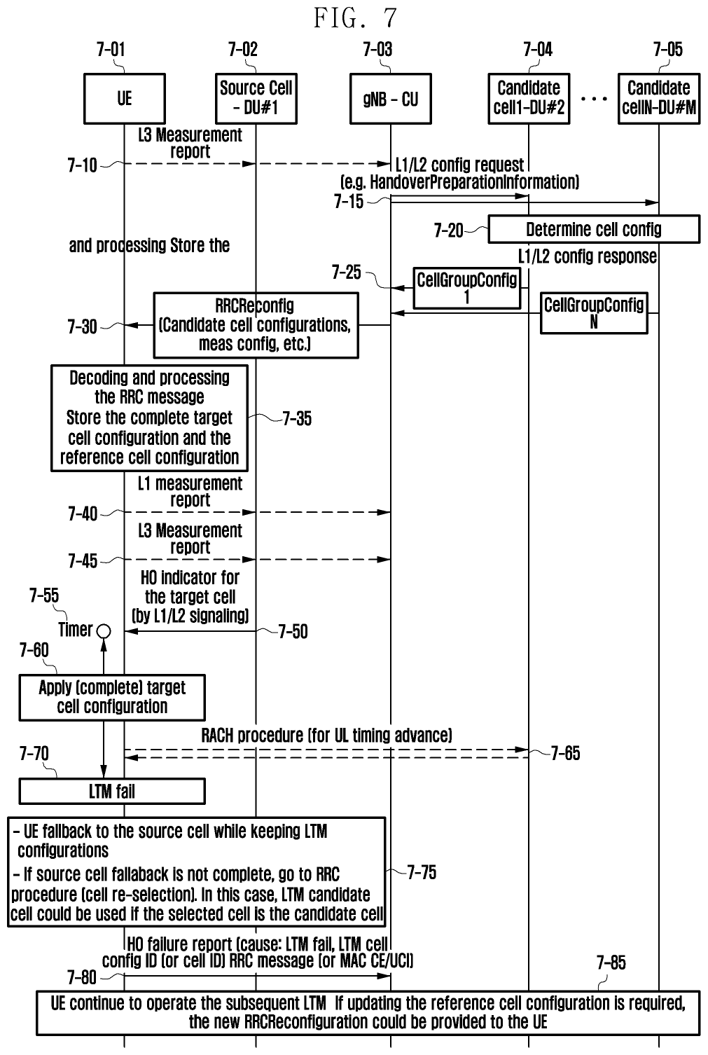

FIG. 7 illustrates operations after a failed subsequent L1/L2-triggered handover (LTM) operation, which is performed based on a reference cell configuration, as an overall operation applied according to an embodiment of the disclosure.

The procedure from operation 7-10 to operation 7-65 in FIG. 7 is identical to the procedure from operation 6-10 to operation 6-65 in FIG. 6, and repeated descriptions thereof will be omitted herein. The procedure in FIG. 6 will be referred to for details.

In operation 7-70, the UE 7-01 may fail in the procedure of LTM handover to the target cell. The reason for the failed LTM handover may include at least one of expiration of the timer for the LTM handover or a legacy T304 timer, or failed random access to the LTM handover target cell. As operation in the case of a failed LTM handover, the UE performs the following operations in operation 7-75.
In the case of an LTM failure, the UE falls back to the previous source cell 7-02 and makes a connection attempt. To this end, the UE needs to maintain configuration information regarding the source cell even if LTM is triggered. In addition, the UE maintains LTM configuration information regarding the LTM target cell and pre-stored reference cell configuration information even after falling back to the source cell 7-02. This is for the purpose of ensuring that LTM can be triggered according to existing configurations.
If the fallback to the source cell is not performed completely, the UE performs an RRC re-establishment procedure and reselects connectable cells. If the cell found through cell reselection is one of LTM candidate cells 7-04 to 7-05, the UE applies a preconfigured RRC configuration to the cell, thereby making a connection attempt. The UE maintains LTM configuration information regarding the LTM target cell and pre-stored reference cell configuration information in this case as well. This is for the purpose of ensuring that LTM can be triggered according to existing configurations.
However, if the cell found through cell reselection after the RRC re-establishment procedure is a cell other than the LTM candidate cells, the UE may maintain LTM configuration information and reference cell configuration information, which have been stored, in the corresponding cell as well. Alternatively, in this case, the stored LTM configuration information and reference cell configuration information may be released. Alternatively, the gNB may explicitly indicate whether the LTM configuration information and reference cell configuration information are to be released or not.

Thereafter, in operation 7-80, the UE generates a handover failure reporting message in the connected cell (source cell or target cell) and delivers the same to the gNB CU 7-03. The handover failure reporting message may be a UEInformationResponse or other uplink RRC message. In addition, the UE may report the handover failure through a new MAC CE or uplink control information. The handover failure reporting message may include at least one of the following pieces of information:
An indicator indicating that the handover failed due to an LTM failure
Information regarding the target cell for which an LTM attempt failed: LTM cell configuration index or physical cell index (PCI) information

In addition, as will be described with regard to operation 7-85, embodiments of the disclosure support a subsequent LTM operation. This means that the UE keeps performing the LTM procedure unless the LTM configuration information (at least one of the configuration regarding target candidate cells or reference cell configuration information) received by the UE in operation 7-30 is stored in the UE such that the LTM configuration information is changed/released/added through a separate RRC configuration. If the reference cell configuration information needs to be updated, new RRC configuration information may be delivered to the UE. That is, the procedure described with reference to FIG. 7 may be triggered and performed again.

To summarize, upon receiving reference cell configuration information in operation 7-30, the UE may store the same in the UE buffer, and if there is no separate configuration-related update, the UE may continuously use the corresponding configuration as reference cell configuration information even after performing LTM (operation 7-50) (that is, the stored reference cell configuration and LTM candidate configuration values are applied to subsequent LTM). In addition, if no reference cell configuration information has been received in the RRC-connected state in operation 7-30, the reference cell configuration may be released and stored according to the UE operation option described above, or configuration information regarding the corresponding source cell (PCell) from which LTM configuration information was received may be stored as reference cell configuration information.

However, as described with regard to operation 7-75, a cell which does not LTM may be reselected after an LTM failure, and the subsequent LTM operation is not supported in this case. The gNB may receive an indicator indicating that the UE has LTM configurations, and may instruct the UE to release LTM-related configurations. Otherwise (if the gNB transmits an LTM approval indicator to the UE, or if the gNB transmits no indicator to the UE), the UE maintains LTM configurations and performs a subsequent LTM operation.

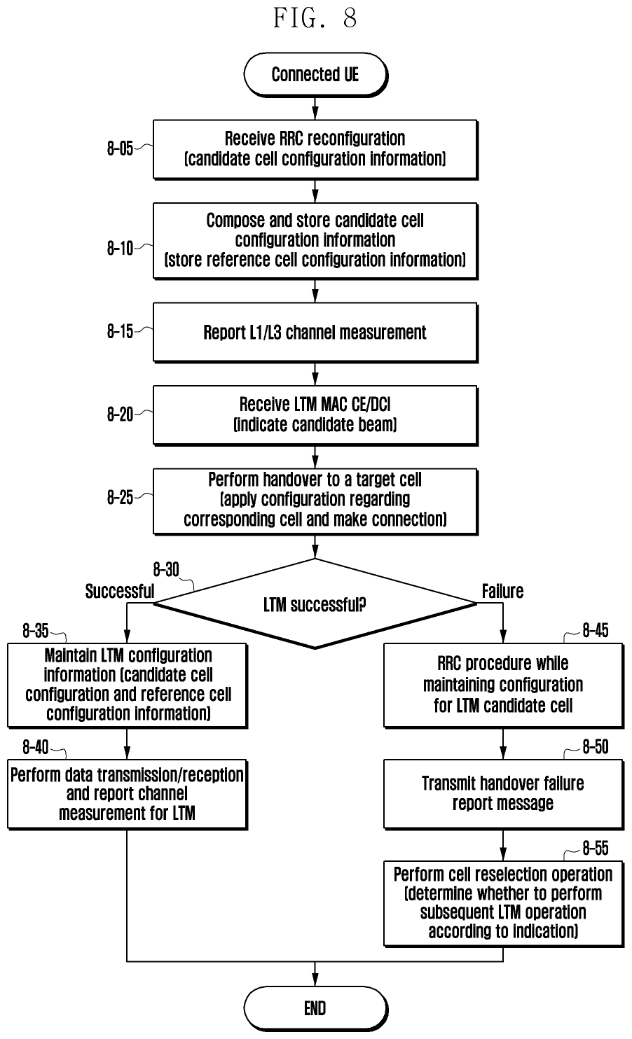

FIG. 8 illustrates overall UE operations of performing L1/L2-triggered beam changes and handovers, according to an embodiment of the disclosure.

UE operations of the disclosure are characterized by a method in which reference cell configuration information for a subsequent LTM operation is managed and is continuously applied.

In operation 8-05, the UE in a connected state may receive configuration information in a neighbor cell, which will be applied after L1/L2-triggered mobility is indicated, through an RRC reconfiguration message from the serving cell. Descriptions made with reference to FIGS. 6 and 7 will be referred to for the configuration method and related details. In addition, although omitted in FIG. 8, before receiving the RRC reconfiguration message, the UE may receive basic RRC configurations from the gNB, and may perform operations of reporting layer 3 measurement values regarding neighbor cells. The configuration information regarding the LTM candidate cell received in operation 8-05 is characterized in that a delta configuration is applied based on the reference cell-related configuration. The UE may identify the reference cell and reference cell-related configuration information known in advance or received through RRC configurations. Reference cell configurations are used as common configurations regarding neighbor cells other than the reference cell, and configurations which can be added thereto are delivered, thereby reducing signaling overhead.

In operation 8-10, the UE may decode configurations regarding LTM candidate cells, based on the reference cell configuration, such that a complete configuration is stored in a separate buffer and a list and managed (that is, a configuration to which a delta configuration is applied, based on the reference cell, may be determined as a complete configuration). Alternatively, the UE may decode received configurations, based on the reference cell configuration, such that actually applied configurations are not stored and managed, and received RRC configurations are stored and managed in the buffer without modification. As described with reference to FIG. 6, the UE may perform one of the following operations if no reference cell configuration is received.
1. First UE operation: if no reference cell configuration information is received, the UE determines that configuration information regarding LTM target candidate cells is complete configuration information, and stores the same. The UE does not separately store reference cell configuration information (operates assuming that the same is empty). That is, no delta configuration is applied.
2. Second UE operation: the UE may be aware that reference cell configuration information is the current source cell's configuration information. The UE determines that received configuration information regarding LTM target candidate cells is complete configuration information by applying the delta configuration to the reference cell configuration information (source cell's configuration), and stores the information. In this case, current source cell configuration information may be explicitly provided to the UE, or the UE may implicitly know the source cell configuration information without an explicit configuration. This may follow rules in standards regarding what common configuration information is applied to the reference cell configuration, or separately distinguished common configuration information may be used.

The advantage obtained by decoding configurations regarding neighbor cells, based on the configurations regarding the reference cell, and storing actually applied configurations in the corresponding step is that, if an L1/L2-triggered handover is actually indicated, the handover regarding the corresponding cell can be instantly applied, thereby causing no additional delay time.

In operation 8-15, the UE performs L1 measurement related to candidate neighbor cells while remaining connected to the serving cell, and reports the measurement result to the serving cell according to a preconfigured L1 measurement reporting method. In addition, independently of the corresponding operation, the UE measures neighbor cells according to L3 measurement configurations and report measurement results to the gNB according to L3 measurement reporting configurations.

The serving cell may determine, based on received measurement results, whether the UE needs to perform a beam change and a handover. Upon determining that a change from a specific beam of the serving cell to a specific beam of a neighbor cell is necessary, the serving cell instructs the UE to perform a handover and a beam change through L1/L2 signaling in operation 8-20. In FIG. 8, the L1/L2 signaling may include a MAC CE or DCI. The MAC CE has all information indicating a specific beam of a neighbor cell and a serving cell change (if the MAC CE indicates only one beam). Alternatively, the MAC CE may indicate multiple specific beams of an LTM target cell, and the DCI may indicate one of multiple beams of a neighbor cell activated by the MAC CE, thereby indicating a handover.

In operation 8-25, the UE identifies whether a handover is indicated from the MAC CE and DCI signaling received in operation 8-15, and performs an LTM handover operation. If the MAC CE and DCI indicates a handover (if the MAC CE itself indicates a handover, or if the MAC CE activates multiple beams, and the DCI indicates one of the beams, thereby indicating a handover), the UE may perform a handover to the cell related to the indicated TCI state. If a handover is successful as a result of successfully performing random access in operation 8-30, the UE applies the stored configuration regarding the LTM target cell.

In operation 8-35, the UE maintains pre-stored LTM configuration information and reference cell configuration information. In operation 8-40, the UE connects to the indicated LTM target cell, transmits/receives data by using the indicated beam, performs channel measurement reporting according to the LTM configuration, and performs the subsequent LTM operation.

If the UE fails in LTM handover in operation 8-30, the UE falls back to the previous source cell and attempts to make connection in operation 8-45. To this end, the UE may maintain configuration information regarding the source cell even if LTM is triggered. In addition, even after falling back to the source cell, the UE maintains LTM configuration information regarding the LTM target cell and reference cell configuration information. This is for the purpose of ensuring that LTM can be triggered again according to existing configurations. If the fallback to the source cell is not performed completely, the UE enters an RRC re-establishment procedure and reselects connectable cells. If the cell found through cell reselection is one of LTM candidate cells, the UE applies a preconfigured RRC configuration to the cell, thereby making a connection attempt.

Thereafter, in operation 8-50, the UE generates a handover failure reporting message in the connected cell (source cell or target cell) and delivers the same to the gNB. The handover failure reporting message may be a UEInformationResponse or other uplink RRC message. In addition, the UE may report the handover failure through a new MAC CE or uplink control information. The handover failure reporting message may include at least one of the following pieces of information:
An indicator indicating that the handover failed due to an LTM failure
Information regarding the target cell for which an LTM attempt failed: LTM cell configuration index or physical cell index (PCI) information

The source gNB may be aware that the LTM attempt failed, and a fallback to the corresponding cell occurred, from the handover failure reporting message. In addition, if the cell found through cell reselection after the RRC re-establishment procedure is a cell other than the LTM candidate cells, the UE may maintain LTM configuration information and reference cell configuration information, which have been stored, in the corresponding cell as well in operation 8-55. Alternatively, the UE may release the stored LTM-related configuration information and reference cell configuration information. Alternatively, the gNB may explicitly indicate, through a configuration, whether the stored LTM-related configuration information and reference cell configuration information are to be released or not.

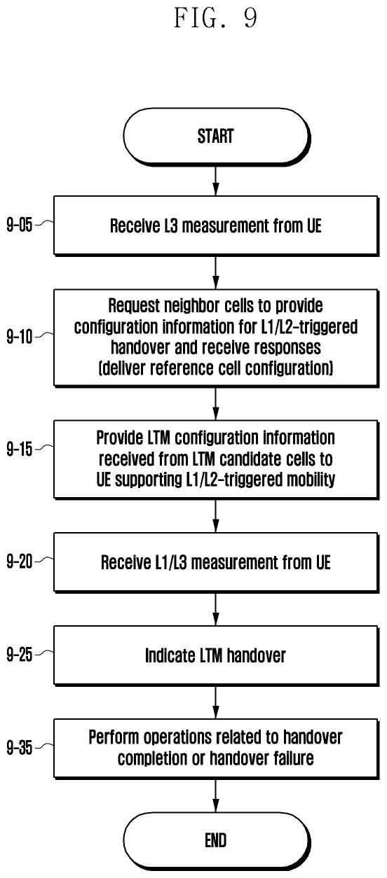

FIG. 9 illustrates gNB operations applied according to an embodiment of the disclosure.

In operation 9-05, the gNB receives an L3 measurement value report from the UE, and identifies, based on the measurement values regarding neighbor frequencies and cells, whether the UE is in a state requiring a handover, what cells are handover candidate cells, and the like.

In operation 9-10, the gNB transmits a configuration information request for an L1/L2-triggered handover to neighbor cells, and receive responses from corresponding cells. In addition, in the step of transmitting a configuration information request, the gNB may deliver configuration information regarding the current source cell and reference cell configuration information to neighbor cells. In addition, the gNB may receive RRC configuration information to which a delta configuration is applied, based on reference cell configuration information, from neighbor cells and LTM candidate cells. As described with reference to FIG. 6, one of the following methods may be applied if the gNB omits reference cell configuration information and requests LTM candidate cells to provide configuration information for an L1/L2-triggered handover.
1. First reference cell configuration omitting method: the target cell (DU) determines that there is no reference cell configuration, determines complete configuration information to be applied to the UE after LTM, and delivers the same to the source gNB CU. That is, the delta configuration is not applied.
2. Second reference cell configuration omitting method: the target cell (DU) determines that configuration information in the current source cell, provided by the source gNB CU, is reference cell configuration information, determines target candidate cell configuration information to which the delta configuration is applicable with reference to the corresponding configuration, and delivers the same to the source gNB CU.
3. Third reference cell configuration omitting method: when the source gNB CU requests the candidate cells to configure LTM, an indicator indicating the “first reference cell configuration omitting method” or the “second reference cell configuration omitting method” may be transmitted. Therefore, the above-described reference cell configuration omitting method may be applied according to the indicator.

Although omitted in FIG. 9, it may be assumed that, prior to the corresponding step, configurations related to L3 measurement configurations and basic RRC configuration have been provided.

In operation 9-15, the gNB transmits an RRC configuration message generated so as to include the neighbor cell configuration information received in operation 9-10, to the UE in a connected state. That is, the gNB delivers configuration information in a neighbor cell, which is to be applied after L1/L2-triggered mobility is indicated, to the UE through an RRC reconfiguration message. The configuration method and related details have been described in detail with reference to FIGS. 6 and 7.

Thereafter, in operation 9-20, the gNB receives a report regarding L1 and L3 measurement values from the UE, and the L1 measurement value may be related to a neighbor cell (non-serving cell) supporting L1/L2 triggered mobility. The gNB may determine, based on the received measurement result, whether the UE needs to perform a beam change and a handover. Upon determining that a change from a specific beam of the serving cell to a specific beam of a neighbor cell is necessary, the gNB instructs the UE to perform an LTM handover through L1/L2 signaling in operation 9-25. The L1/L2 signaling may be a MAC CE or DCI, and includes information indicating a change to a specific beam of a neighbor cell. In addition, in the corresponding step, a legacy handover may be independently indicated through an RRC message. This is because LTM and layer 3 handover determination are performed independently.

Thereafter, in operation 9-35, upon receiving a handover completion message from the UE, the gNB may confirm that the LTM operation is successfully completed. In addition, the gNB informs the previous source cell of handover completion, and requests UE context release.

In addition, upon receiving a handover failure reporting message including handover failure information, the gNB receives a message indicating that the UE again attempted to connect to the corresponding cell after the handover failure. The handover failure reporting message may be a UEInformationResponse or other uplink RRC message. In addition, the handover failure reporting message may include a new MAC CE or uplink control information. The handover failure reporting message may include at least one of the following pieces of information:
An indicator indicating that the handover failed due to an LTM failure
Information regarding the target cell for which an LTM attempt failed: LTM cell configuration index or physical cell index (PCI) information

The gNB may be aware that the LTM attempt failed, and a fallback to the corresponding cell occurred, from the handover failure reporting message.

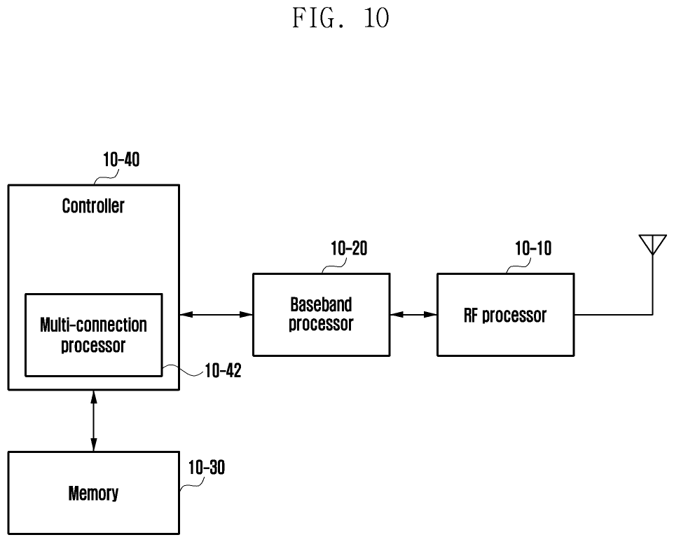

FIG. 10 is a block diagram illustrating the internal structure of a UE to which according to an embodiment of the disclosure.

Referring to FIG. 10, the UE may include a radio frequency (RF) processor 10-10, a baseband processor 10-20, memory 10-30, and a controller 10-40 including a multi-connection processor 10-42.

The RF processor 10-10 performs functions for transmitting/receiving signals through a radio channel, such as signal band conversion and amplification. That is, the RF processor 10-10 up-converts a baseband signal provided from the baseband processor 10-20 to an RF band signal, transmits the same through an antenna, and down-converts an RF band signal received through the antenna. For example, the RF processor 10-10 may include a transmission filter, a reception filter, an amplifier, a mixer, an oscillator, a digital-to-analog converter (DAC), and an analog-to-digital converter (ADC) and the like. Although only one antenna is illustrated in FIG. 10, the UE may include multiple antennas. In addition, the RF processor 10-10 may include multiple RF chains. Furthermore, the RF processor 10-10 may perform beamforming. For the beamforming, the RF processor 10-10 may adjust the phase and magnitude of signals transmitted/received through multiple antennas or antenna elements, respectively. In addition, the RF processor may perform MIMO, and may receive multiple layers when performing a MIMO operation.

The baseband processor 10-20 performs functions of conversion between baseband signals and bitstrings according to the system's physical layer specifications. For example, during data transmission, the baseband processor 10-20 encodes and modulates a transmitted bitstring to generate complex symbols. In addition, during data reception, the baseband processor 10-20 demodulates and decodes a baseband signal provided from the RF processor 10-10 to restore a received bitstring. For example, when following the orthogonal frequency division multiplexing (OFDM) scheme, during data transmission, the baseband processor 10-20 encodes and modulates a transmitted bitstring to generate complex symbols, maps the complex symbols to subcarriers, and configures OFDM symbols through inverse fast Fourier transform (IFFT) operation and cyclic prefix (CP) insertion. In addition, during data reception, the baseband processor 10-20 splits a baseband signal provided from the RF processor 10-10 at the OFDM symbol level, restores signals mapped to subcarriers through fast Fourier transform (FFT) operation, and restores a received bitstring through demodulation and decoding.

The baseband processor 10-20 and the RF processor 10-10 transmit and receive signals as described above. Therefore, the baseband processor 10-20 and the RF processor 10-10 may be referred to as a transmitter, a receiver, a transceiver, or a communication unit. Furthermore, at least one of the baseband processor 10-20 and the RF processor 10-10 may include multiple communication modules to support multiple different radio access technologies. In addition, at least one of the baseband processor 10-20 and the RF processor 10-10 may include different communication modules to process signals in different frequency bands. For example, the different radio access technologies may include wireless LANs (for example, IEEE 802.11), cellular networks (for example, LTE), and the like. In addition, the different frequency bands may include a super high frequency (SHF) (for example, 2.NRHz, NRhz) bands and millimeter wave (for example, 60 GHz) bands.

The memory 10-30 stores data such as basic programs for operation of the UE, application programs, configuration information. Particularly, the memory 10-30 may store information related to a second access node which performs radio communication by using a second radio access technology. In addition, the memory 10-30 provides the stored data at the request of the controller 10-40.

The controller 10-40 controls overall operations of the UE. For example, the controller 10-40 transmits/receives signals through the baseband processor 10-20 and the RF processor 10-10. In addition, the controller 10-40 records and reads data in the memory 10-30. To this end, the controller 10-40 may include at least one processor. For example, the controller 10-40 may include a communication processor (CP) configured to perform control for communication, and an application processor (AP) configured to control upper layers such as application programs.

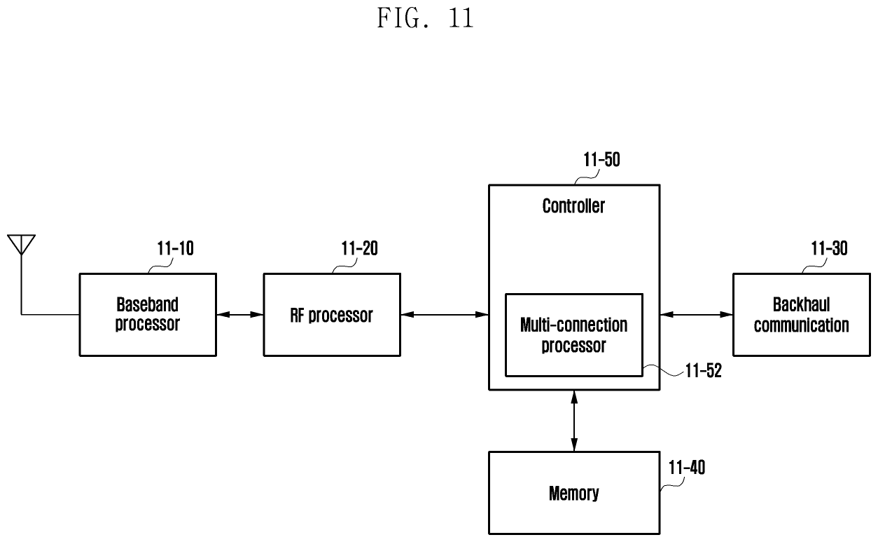

FIG. 11 is a block diagram illustrating the configuration of a gNB according to an embodiment of the disclosure.

Referring to FIG. 11, the gNB may include an RF processor 11-20, a baseband processor 11-10, a backhaul communication unit 11-30, memory 11-40, and a controller 11-50 including a multi-connection processor 11-52.

The RF processor 11-20 performs functions for transmitting/receiving signals through a radio channel, such as signal band conversion and amplification. That is, the RF processor 11-20 up-converts a baseband signal provided from the baseband processor 11-10 to an RF band signal, transmits the same through an antenna, and down-converts an RF band signal received through the antenna to a baseband signal. For example, the RF processor 11-20 may include a transmission filter, a reception filter, an amplifier, a mixer, an oscillator, a DAC, and an ADC. Although only one antenna is illustrated in FIG. 11, the first access node may include multiple antennas. In addition, the RF processor 11-20 may include multiple RF chains. Furthermore, the RF processor 11-10 may perform beamforming. For the beamforming, the RF processor 11-20 may adjust the phase and magnitude of signals transmitted/received through multiple antennas or antenna elements, respectively. The RF processor may transmit one or more layers to perform a downward MIMO operation.

The baseband processor 11-10 performs functions of conversion between baseband signals and bitstrings according to the physical layer specifications of first radio access technology. For example, during data transmission, the baseband processor 11-10 encodes and modulates a transmitted bitstring to generate complex symbols. In addition, during data reception, the baseband processor 11-10 demodulates and decodes a baseband signal provided from the RF processor 11-20 to restore a received bitstring. For example, when following the OFDM scheme, during data transmission, the baseband processor 11-10 encodes and modulates a transmitted bitstring to generate complex symbols, maps the complex symbols to subcarriers, and configures OFDM symbols through IFFT operation and CP insertion. In addition, during data reception, the baseband processor 11-10 splits a baseband signal provided from the RF processor 11-20 at the OFDM symbol level, restores signals mapped to subcarriers through FFT operation, and restores a received bitstring through demodulation and decoding. The baseband processor 11-10 and the RF processor 11-20 transmit and receive signals as described above. Therefore, the baseband processor 11-10 and the RF processor 11-20 may be referred to as a transmitter, a receiver, a transceiver, a communication unit, or a wireless communication unit.

The backhaul communication unit 11-30 provides an interface for communicating with other nodes in the network. That is, the backhaul communication unit 11-30 converts bitstrings transmitted from the main gNB to other nodes (for example, auxiliary gNB, core network, and the like) to physical signals, and converts physical signals received from the other nodes to bitstrings.

The memory 11-40 stores data such as basic programs for operation of the main gNB, application programs, configuration information. Particularly, the memory 11-40 may store information regarding a bearer allocated to a connected UE, a measurement result reported from the connected UE, and the like. In addition, the memory 11-40 may store information serving as a reference to determine whether to provide multi-connection to a UE or to suspend the same. In addition, the memory 11-40 provides the stored data at the request of the controller 11-50.

The controller 11-50 controls overall operations of the main gNB. For example, the controller 11-50 transmits/receives signals through the baseband processor 11-10 and the RF processor 11-20 or through the backhaul communication unit 11-30. In addition, the controller 11-50 records and reads data in the memory 11-40. To this end, the controller 11-50 may include at least one processor.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a communication system, the method comprising:
receiving, from a gNodeB (gNB), a radio resource control (RRC) message including at least one layer 1/layer 2 triggered mobility (LTM) candidate configuration;
receiving, from the gNB, a medium access control (MAC) control element (CE) associated with an LTM;
identifying that an LTM is triggered based on the MAC CE; and
applying an LTM candidate configuration for the LTM in case that the LTM candidate configuration includes information indicating that the LTM candidate configuration is a complete configuration.

2. The method of claim 1, further comprising:
applying the LTM candidate configuration on top of an LTM reference configuration for the LTM in case that the LTM candidate configuration does not include the information.

3. The method of claim 1, wherein the information is configured for each of the at least one LTM candidate configuration.

4. The method of claim 2, wherein the LTM reference configuration is received from the gNB.

5. A method performed by a central unit (CU) associated with a gNodeB (gNB) in a communication system, the method comprising:
transmitting, to a distributed unit (DU) associated with the gNB, a context setup request message;
receiving, from the DU, a response message including at least one layer 1/layer 2 triggered mobility (LTM) candidate configuration as a response to the context setup request message;
transmitting, to a terminal, a radio resource control (RRC) message including the at least one LTM candidate configuration; and
transmitting, to the terminal, a medium access control (MAC) control element (CE) associated with an LTM,
wherein an LTM candidate configuration for the LTM is applied in case that the LTM candidate configuration includes information indicating that the LTM candidate configuration is a complete configuration.

6. The method of claim 5, wherein the LTM candidate configuration on top of an LTM reference configuration is applied in case that the LTM candidate configuration does not include the information.

7. The method of claim 5, wherein the information is configured for each of the at least one LTM candidate configuration.

8. The method of claim 6, wherein the LTM reference configuration is configured by the gNB.

9. A terminal in a communication system, the terminal comprising:
a transceiver; and
at least one processor coupled to the transceiver and configured to:
receive, from a gNodeB (gNB), a radio resource control (RRC) message including at least one layer 1/layer 2 triggered mobility (LTM) candidate configuration,
receive, from the gNB, a medium access control (MAC) control element (CE) associated with an LTM,
identify that the LTM is triggered based on the MAC CE, and
apply an LTM candidate configuration for the LTM in case that the LTM candidate configuration includes information indicating that the LTM candidate configuration is a complete configuration.

10. The terminal of claim 9, wherein the at least one processor further configured to apply the LTM candidate configuration on top of an LTM reference configuration for the LTM in case that the LTM candidate configuration does not include the information.

11. The terminal of claim 9, wherein the information is configured for each of the at least one LTM candidate configuration.

12. The terminal of claim 10, wherein the LTM reference configuration is received from the gNB.

13. A central unit (CU) associated with a gNodeB (gNB), the CU comprising:
a transceiver; and
at least one processor coupled to the transceiver and configured to:
transmit, to a distributed unit (DU) associated with the gNB, a context setup request message,
receive, from the DU, a response message including at least one layer 1/layer 2 triggered mobility (LTM) candidate configuration as a response to the context setup request message, and
transmit, to a terminal, a radio resource control (RRC) message including the at least one LTM candidate configuration, and
transmit, to the terminal, a medium access control (MAC) control element (CE) associated with an LTM,
wherein an LTM candidate configuration for the LTM is applied in case that the LTM candidate configuration includes information indicating that the LTM candidate configuration is a complete configuration.

14. The CU of claim 13, wherein the LTM candidate configuration on top of an LTM reference configuration is applied in case that the LTM candidate configuration does not include the information.

15. The CU of claim 13, wherein the information is configured for each of the at least one LTM candidate configuration.

16. The CU of claim 14, wherein the LTM reference configuration is configured by the gNB.
